(19) United States
(12) Patent Application Publication
(10) Pub. No.: US 2013/0221906 A1
(43) Pub. Date: Aug. 29, 2013

(54) Lithium Polymer Battery Charger and Methods Therefor

(71) Applicant: Ray Imblum, Corona, CA (US)

(72) Inventor: Ray Imblum, Corona, CA (US)

(73) Assignee: HPV TECHNOLOGIES, INC., Irvine, CA (US)

(21) Appl. No.: 13/814,720

(22) PCT Filed: Aug. 8, 2011
(86) PCT No.: PCT/US2011/046925

§ 371 Date: May 13, 2013

Related U.S. Application Data
(60) Provisional application No. 61/371,425, filed on Aug. 6, 2010.

(51) Int. Cl. H02J 7/00

(52) U.S. Cl. CPC H02J 7/007; H02J 7/0052
USPC 320/107; 320/162

(57) ABSTRACT

Lithium polymer battery are charged from any point of discharge using methods and devices in which the lithium polymer battery is operated during the charge operation as a variable current sink. Most preferably, charging above a threshold voltage is performed such that the charge current is based on a predetermined charge current profile and measured virtual back current resistance.

This application claims priority to PCT International Patent Application No. PCT/US2011/046925 filed Aug. 8, 2011 and U.S. Provisional Patent Application No. 61/371,425, filed Aug. 6, 2010 and is incorporated herein by reference in its entirety.

### FIELD OF THE INVENTION

The field of the invention is devices for charging lithium polymer batteries and methods therefor.

### BACKGROUND OF THE INVENTION

Numerous battery redox chemistries are known in the art, and the choice of redox couple is often dependent on the particular function, capacity, and other desired parameter. For example, where secondary batteries are required to have a high current output and energy to weight ratio, lithium has become the preferred redox element. Two types of batteries that employ lithium as redox elements are predominant in many consumer electronic devices, lithium ion batteries, and more recently, lithium polymer batteries that contain the lithium salt electrolyte in a solid polymer composite (e.g., using polyethylene oxide or polyacrylonitrile) rather than a liquid as is the case with lithium ion batteries.

Most typically, lithium polymer batteries comprise a LiCoO₂ or LiMn₂O₄ cathode, a Li or carbon-Li intercalation compound anode, and a conductive solid polymer electrolyte. Thus, Li is oxidized at the anode during discharge forming Li⁺ and yields the current, while the cathode reaction produces LiCoO₂ from Li₁₋ₓCoO₂, xLi⁺, and xe⁻. In such batteries, the separator acts as the electrolyte, conducts the flow of Li⁺, and is generally a chemically modified polymer (e.g., modified PVDF or polyethylene oxide). Among other advantages, lithium polymer batteries tend to have little or no memory effect and self-discharge, provide high specific energy densities, and have a high open cell voltage.

However, lithium polymer batteries have several drawbacks. Due to their specific redox chemistry and configurations, the voltage of lithium polymer cell varies from about 2.7 V (near discharged) to about 4.23 V (charged), and the load must be disconnected from the battery when the voltage drops below about 3.0 V to avoid subsequent incomplete charging and loss of capacity. Similarly, charging a lithium polymer battery is often performed by observing the cell voltage. Once the cell voltage reaches 4.2 V (which is equivalent to about 70% of full capacity), the charge current is typically held constant at 4.2V and current is delivered using a timer or until the charge current reaches a set % of the discharge current as accidental overcharging may lead to plating of lithium, heat and gas evolution due to parasitic reactions, and even total loss of the battery due to fire or explosion.

For example, one method of avoiding the risk for overcharging is to use a two-step charging process (Constant Current Constant Voltage, CCCV). Usually, the constant voltage CV of a lithium cell is 4.2 V. With the CCCV method, the battery cell is first charged with a constant current until the voltage in the cell reaches 4.2 V. Once this level has been reached, a charging control system regulates the charging of the cell at 4.2 V in the subsequent step, and proceeds with the charging until the charging current has dropped to a predetermined current value. Once the predetermined current level has been detected or a given time limit has been reached, the cell is assumed to be fully charged. Additional safety procedures (e.g., timer or charging current has not decreased during set time) may be implemented to this scheme as described in WO 2010/046145. Alternatively, in other known charge methods, a lithium polymer battery is first discharged to a predetermined level, and then re-charged using a timed charge mode.

In another example, EP 1 729 394 teaches a stepwise descending constant current charge mode in which each successive charge step is performed at a lower charge current than the prior step. Alternatively, as described in EP 1 455 1394 and WO 2004/079383, upon reaching a cell voltage of 4.2V, a charge measurement value is established and the supply of the charging current is terminated dependent on the measured charge and a predetermined charge level value. Thus, such methods are typically both time and current dependent.

In still further known examples, U.S. Pat. No. 7,615,969 teaches systems and methods in which the battery cell charge current is controlled on the basis of a temperature increase relative to ambient temperature conditions to which battery cells of a battery are exposed. WO 00/76049 teaches pulse charge systems and methods, and U.S. Pat. No. 7,786,706 teaches systems and methods for pulse charge operation of a battery charger where the charge process is stopped when the current in the pulse charge operation is not greater than a predetermined value and where the rechargeable battery is charged at constant voltage when the current in the pulse charge operation is greater than the predetermined value.

In yet another example, as published in U.S. Pat. App. No. 2011/0156660, a quick-charge method for lithium polymer batteries is presented where charging is stopped when the battery is charged to a charge limit voltage U that is defined as 2Uo-Us, where Us is a stabilized voltage which the voltage of the battery falls back to after the voltage of the battery is charged to Uo at a constant current, and where Uo is a standard charge cutoff voltage used by a low rate constant current-constant voltage charging mode. Where multiple cells are present in a battery pack, load balancing can be implemented by measuring the state of charge of each cell and adjusting a charger accordingly to avoid overcharging a battery pack as taught in U.S. Pat. No. 5,773,959.

While most of these known methods and devices will allow charging lithium polymer batteries in a relatively effective and safe manner, such methods and devices will generally fail to allow for a trickle charge mode, which is particularly disadvantageous where devices powered by lithium polymer batteries are only intermittently used but require quick charging to a fully charged state.

Thus, while there are many known manners of charging a lithium polymer battery, all or almost all of them suffer from one or more disadvantages. Therefore, there is still a need to provide improved devices and methods for charging such batteries.

### SUMMARY OF THE INVENTION

The present inventive subject matter is direct to lithium polymer battery chargers and methods of charging a lithium polymer battery in a manner that allows the battery to be charged at any point of charge. Thus, contemplated chargers and methods may be viewed as lithium polymer battery trickle chargers, which was heretofore not considered feasible.

In one especially preferred aspect of the inventive subject matter, a charge control device for use with a lithium polymer battery charger comprises a charge control circuit that receives a first signal that is representative of a charge current into a lithium polymer battery, and that receives a second signal representative of a charge voltage of the lithium polymer battery. Most typically, the control circuit provides a control signal to a battery charger that causes the charger to charge the lithium polymer battery at constant charge current so long as the charge voltage is below a threshold voltage. Once the charge voltage is at the predetermined threshold voltage, the control circuit causes the charger to charge the battery at a constant charge voltage and at a variable charge current that is based on the first signal and a known charge current profile for a particular lithium polymer battery.

While not limiting to the inventive subject matter, it is generally preferred that the charge control circuit is integrated with the battery charger, and/or that the threshold voltage is 4.2V. It is still further generally preferred that the battery charger or the lithium polymer battery comprises a memory element that is programmed to include data representative of the known charge current profile for the lithium polymer battery. Similarly, it is contemplated that the lithium polymer battery or the battery charger includes a current sensor.

Consequently, and in another especially preferred aspect of the inventive subject matter, a method of facilitating charging of a partially discharged lithium polymer battery at any state of charge will include a step in which a lithium polymer battery charger and/or a lithium polymer battery is configured such that the battery charger, at or above a threshold charge voltage, charges the lithium polymer battery at a constant voltage using a variable charge current, wherein the variable charge current is determined by a measured charge current at any given time point and a predetermined charge current profile for the lithium polymer battery.

In most preferred aspects of the inventive subject matter, the lithium polymer battery charger and/or the battery has a memory element that is programmed to include data representative of the predetermined charge current profile and/or a current sensor. As before, it is typically preferred that the threshold charge voltage is 4.2V. It should also be appreciated that the variable charge current may be further adjusted based on data related to ambient temperature, battery temperature, and/or number of previous charge cycles. Most typically, charging is terminated at 90-95% of full charge, and that the lithium polymer battery is charged at a constant charge current (most preferably equal to the maximum current supply capability of the battery) below the threshold charge voltage.

Viewed from another perspective, the inventor also contemplates a method of charging a partially discharged lithium polymer battery in which in one step the charge voltage and/or the charge current flowing into the lithium polymer battery is measured during charging. In another step, the lithium polymer battery is charged at a constant charge current so long as the charge voltage is below a threshold voltage, and upon reaching the threshold voltage, the lithium polymer battery is charged at a constant voltage using a variable charge current. Most preferably, the variable charge current is based on the measured charge current and a predetermined charge current profile for the lithium polymer battery.

In typical exemplary methods, the step of measuring the charge current comprises a step of measuring the current with a current sensor that is integrated with the battery, and/or the constant charge current is the maximum current supply capability of the battery. As noted above, it is generally preferred that charging is terminated at 90-95% of full charge, and/or that the threshold charge voltage is 4.2V. it should further be appreciated that the predetermined charge current profile may be provided by the lithium polymer battery and/or the battery charger.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1A is an exemplary schematic illustration of a charging process for a lithium polymer battery in which charge voltage and charge current mode is depicted as a function of time/charge current.

FIG. 1B is an exemplary graph depicting two individual and predetermined charge current profiles for two distinct lithium polymer batteries in which charge current is depicted as a function of state of charge for each battery.

FIG. 2 is a schematic of an exemplary charge control device coupled to a lithium polymer battery and a battery charger.

### DETAILED DESCRIPTION

The inventor has now discovered that a lithium polymer battery can be charged from any point of discharge using methods and devices in which the lithium polymer battery is operated during the charge operation as a variable current sink. Most preferably, the lithium polymer battery has, or is electronically coupled to one or more current sensors that is/are configured to determine the direction of current flow and to determine the magnitude of the current flow.

In especially preferred aspects, the current sensor will provide a signal to the battery charger, typically via a charge control device, to thereby adjust the charge current that flows into the battery based on a predetermined charge current profile for a specific type of lithium polymer battery and based on virtual back current resistance (that is based on the measured magnitude of current flow when the cell voltage is 4.2V) at the time of charging. Using such methods and devices, it should be particularly appreciated that a lithium polymer battery can now be charged from any charge status to a substantially complete charge (e.g., 90% or 95% fully charged) without risking overcharging and/or any other adverse electrochemical side reactions. This is particularly advantageous where the battery is discharged to a level where the cell voltage is still 4.2V (or between 4.15V to 4.25V, or between 4.2V +/−25 mV).

In especially preferred aspects of the inventive subject matter, the charge voltage of the lithium polymer battery is determined by a sensor located in the battery, in the charge control device, and/or in the charger upon electrically coupling of the battery to the charger. When the voltage of the battery is below a predetermined threshold (typically between 4.0V to 4.3V, more typically between 4.15V to 4.25V, and most typically at 4.2V +/−25 mV), the charger will operate at constant current, which is most typically at 0.1C to 2.0 C of the battery, more typically at 0.5C to 1.5 C of the battery, and most typically 0.8C to 1.2 C of the battery. In particularly preferred aspects, the constant current is at 1C. It is further generally preferred that the voltage is at least periodically (and more typically continuously) measured during charging of the battery until the charge voltage reaches the predetermined threshold voltage (e.g., 4.2V).

At that time, the charging mode is changed from constant current to variable current mode. It should be particularly appreciated that the variable current mode will be determined by at least two factors: Virtual back current resistance and a predetermined charge current profile for the specific type of lithium polymer battery that is being charged. In this context it should be appreciated that as the battery charge upon reaching the threshold voltage increases and approaches fully or nearly fully charged state, the amount of current delivered to the battery at the threshold voltage will decrease. Of course, it should be recognized that each type of lithium polymer battery will have its own particular virtual back current resistance characteristics, depending, inter alia, on the number of cells, cell capacity, etc.

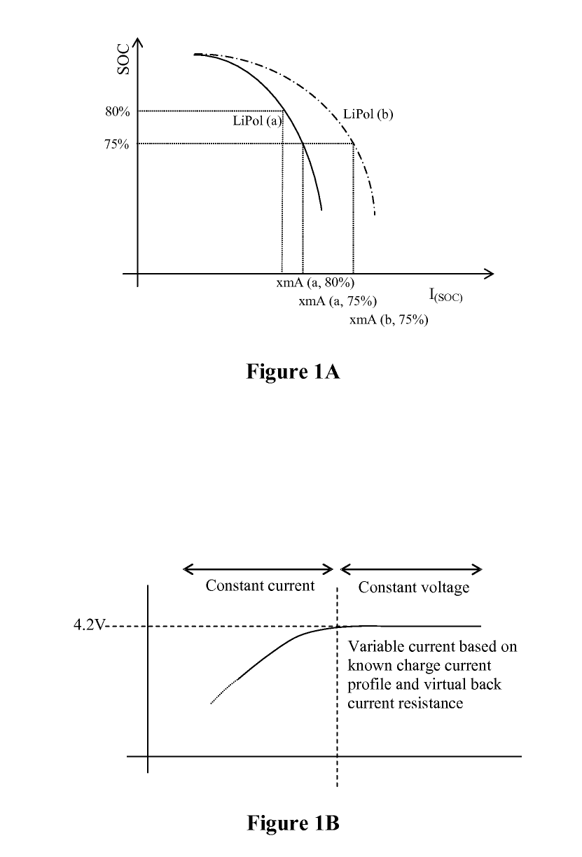

FIG. 1A exemplarily depicts a graph illustrating two distinct charge current profile for two distinct types of lithium polymer batteries. Here, the charge current profile for lithium polymer battery (a) is shown as solid line and for lithium polymer battery (b) is shown in a dash-dot line. As is readily apparent, battery (a) has a substantially lower charge current at 75% of full charge than battery (b). As should also be readily apparent, the charge current decreases for each battery with increased charge state (as the virtual back current resistance increases). SOC in FIG. 1A denotes state of charge of the battery, and I_{(SOC)} denotes charge current at a given state of charge. Of course, it should be recognized that the charge current profiles are relevant and shown only with respect to the charging operation above the threshold voltage. Once a charge current profile has been determined for a specific lithium polymer battery, it should be appreciated that by determination of the charge current (where the charge voltage is above the threshold voltage) upon initiation of charging operation the state of charge of the battery is immediately known from the charge current profile, and the appropriate charge current can be applied to the battery to charge the battery to any desired capacity without encountering adverse electrochemical side reactions.

FIG. 1B schematically depict such operation where charging is performed at constant current until the battery reaches the predetermined threshold voltage. At that point, charging operation is switched to constant voltage using a variable current profile that is based on the known charge current profile and measured charge current (virtual back current resistance). Consequently, it should be recognized that universal battery chargers for lithium polymer batteries are possible that not only allow to charge a variety of lithium polymer batteries in a highly effective and safe manner, but also allow to operate a lithium polymer battery charger as a trickle charger that is capable of topping off the battery charge even where the battery is at the threshold voltage. Viewed from a different perspective, it is noted that once the individual virtual back current resistance characteristics are known for a particular type of battery, any lithium polymer battery can be charged to any desired charge state (typically 90%) from any state of discharge. Most typically, this is achieved by first determining a discharge voltage of the battery and charging the battery at constant charge current provided the discharge voltage is below 4.2V, and by using a stage-specific charge current based on a predetermined charge current profile and virtual back current resistance when the discharge voltage is 4.2V.

With respect to the charger, it should be appreciated that all known chargers are deemed suitable for use herein, so long as such chargers are operable as constant current chargers at battery voltages below a predetermined threshold (typically 4.2V) and further so long as such chargers are operable as variable current chargers once the predetermined threshold (typically 4.2V) is reached. Most typically, contemplated chargers and/or lithium batteries will include a charge control device that includes a charge control circuit that is configured to receive (a) a first signal that is representative of the charge current into the battery, and (b) a second signal that is representative of the charge voltage of the lithium polymer battery. The control circuit is typically also configured to provide a control signal to the battery charger to set the charger to constant charge current mode as long as the charge voltage is below a threshold voltage and to set the charger to constant charge voltage and variable charge current mode when the charge voltage is at the predetermined threshold voltage. The variable charge current in such systems is based on the first signal and a predetermined charge current profile for a particular lithium polymer battery when the charge voltage is at the predetermined threshold voltage.

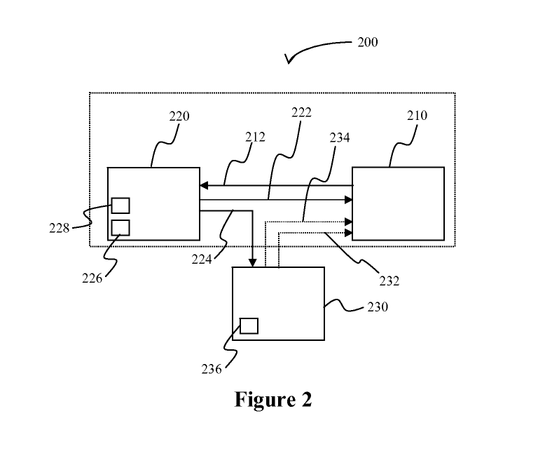

An exemplary lithium battery charge configuration 200 is depicted in FIG. 2, where charge control circuit 210 is in a common housing (dashed lines) with battery charger 220. Lithium polymer battery 230 is electrically/logically coupled to the charger and the control circuit as described in further detail below. With respect to the connections depicted in the Figure, it should be noted that this illustration is schematic and not representative of actual wiring, and the person of ordinary skill in the art will be readily able to implement the schematic of the Figure into one or more physical connections in numerous manners. In the example of FIG. 2 the battery charger 220 includes a memory element 226 in which at least one (and more typically a plurality of distinct) charge current profile for a (typically plurality of distinct) lithium polymer batteries are stored. Current sensor 228 is also integrated with charger 220. First signal 232 (indicating charge current) is provided to the charge control circuit 210 while current 224 is delivered to the battery. Similarly, second signal 234 (indicating charge voltage) is provided to the charge control circuit 210. Where desired, battery 230 may also include a memory element 236 that stores a charge current profile specific to the battery. Control signal 212 is provide from the charge control circuit 210 to the battery charger 220 to effect constant charge current mode so long as the charge voltage is below a threshold voltage.

Consequently, it should be appreciated that devices contemplated herein will allow charging of a partially discharged lithium polymer battery where the charge voltage and/or the charge current flowing into a lithium polymer battery is measured during charging, where the lithium polymer battery is charged at a constant charge current so long as the charge voltage is below a threshold voltage, and where, upon reaching the threshold voltage, the lithium polymer battery is charged at a constant voltage using a variable charge current. As before, the variable charge current is based on a measured charge current and a known charge current profile for a specific lithium polymer battery. Viewed from yet another perspective, a method of facilitating charging of a partially discharged lithium polymer battery at any state of charge will therefore include a step of configuring a lithium polymer battery charger and/or a lithium polymer battery such that the battery charger, above a threshold charge voltage, charges the lithium polymer battery at a constant voltage using a variable charge current (as before, the variable charge current is determined by a measured charge current and a predetermined charge current profile for the lithium polymer battery).

With respect to the charge control circuit, it should be appreciated that the circuit may be integrated with the lithium polymer battery or the battery charger as a single circuit or as distributed circuit with one component on the battery and another component on the charger. Likewise, it is contemplated that the current sensor may be located in any component of contemplated systems, the charge control circuit, the battery, and/or the charger. While it is further preferred that the battery includes a memory element that includes data representative of the charge current profile for the battery, it is also contemplated that the charger may comprise a memory element that includes multiple distinct data representative of the charge current profile for multiple distinct batteries.

Additionally, it should be appreciated that the charge profile may be corrected to so compensate for age of the battery, for the number of charge cycles of the battery, and/or for ambient/charging temperature. Similarly, it should be noted that the charger is preferably configured to allow load balancing among multiple cells where a plurality of cells are present.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . , and N, the text should be interpreted as requiring only one element from the group, not A plus N, or B plus N, etc.

What is claimed is:

1. A charge control device for use with a lithium polymer battery charger, comprising:
a charge control circuit configured to receive a first signal representative of a charge current into a lithium polymer battery, and a second signal representative of a charge voltage of the lithium polymer battery;
wherein the control circuit is further configured provide a control signal to a charger to thereby cause the charger to charge the lithium polymer battery at constant charge current so long as the charge voltage is below a threshold voltage; and
wherein the control circuit is still further configured to allow operation of the charger at a constant charge voltage and at a variable charge current that is based on the first signal and a predetermined charge current profile for the lithium polymer battery when the charge voltage is at the predetermined threshold voltage.

2. The charge control device of claim 1 wherein the charge control circuit is integrated with the battery charger.

3. The charge control device of claim 1 wherein the threshold voltage is 4.2V.

4. The charge control device of claim 1 wherein the battery charger comprises a memory element that is programmed to include data representative of the predetermined charge current profile for the lithium polymer battery.

5. The charge control device of claim 1 wherein the lithium polymer battery comprises a memory element that is programmed to include data representative of the predetermined charge current profile for the lithium polymer battery.

6. The charge control device of claim 1 wherein the battery charger comprises a current sensor.

7. A method of facilitating charging of a partially discharged lithium polymer battery at any state of charge, comprising:
configuring at least one of a lithium polymer battery charger and a lithium polymer battery such that the battery charger, above a threshold charge voltage, charges the lithium polymer battery at a constant voltage using a variable charge current;
wherein the variable charge current is determined by a measured charge current and a predetermined charge current profile for the lithium polymer battery.

8. The method of claim 7 wherein the lithium polymer battery charger comprises at least one of a memory element that is programmed to include data representative of the predetermined charge current profile and a current sensor.

9. The method of claim 7 wherein the lithium polymer battery comprises at least one of a memory element that is programmed to include data representative of the predetermined charge current profile and a current sensor.

10. The method of claim 7 wherein the threshold charge voltage is 4.2V.

11. The method of claim 7 further comprising a step of adjusting the variable charge current using data based on at least one of ambient temperature and number of previous charge cycles.

12. The method of claim 7 wherein charging is terminated at 90% of full charge.

13. The method of claim 7 wherein the at least one of the lithium polymer battery charger and the lithium polymer battery are further configured such that the battery charger, below the threshold charge voltage, charges the lithium polymer battery at a constant charge current, and wherein the constant charge current is equal to maximum current supply capability of the battery.

14. A method of charging a partially discharged lithium polymer battery, comprising:
measuring at least one of a charge voltage and a charge current flowing into a lithium polymer battery during charging;
charging the lithium polymer battery at a constant charge current so long as the charge voltage is below a threshold voltage; and
upon reaching the threshold voltage charging the lithium polymer battery at a constant voltage using a variable charge current;
wherein the variable charge current is based on the measured charge current and a predetermined charge current profile for the lithium polymer battery.

15. The method of claim 14 wherein the step of measuring the charge current comprises measuring with a current sensor that is integrated with the battery.

16. The method of claim 14 wherein the constant charge current is maximum current supply capability of the battery.

17. The method of claim 14 wherein charging is terminated at 90% of full charge.

18. The method of claim 14 wherein the threshold charge voltage is 4.2V.

19. The method of claim 14 wherein the predetermined charge current profile is provided by the lithium polymer battery.

20. The method of claim 14 wherein the predetermined charge current profile is provide by the battery charger.
